(19) United States
(12) Patent Application Publication
(10) Pub. No.: US 2019/0109550 A1
(43) Pub. Date: Apr. 11, 2019

(54) METHOD OF CONTROLLING STEPPING MOTOR

(71) Applicant: CANON KABUSHIKI KAISHA, Tokyo (JP)

(72) Inventor: Takayuki Fukutani, Mishima-shi (JP)

(21) Appl. No.: 16/145,507

(22) Filed: Sep. 28, 2018

(30) Foreign Application Priority Data
Oct. 5, 2017 (JP) 2017-195372

(51) Int. Cl. H02P 8/12; G03G 15/00

(52) U.S. Cl. CPC H02P 8/12; G03G 15/6529

(57) ABSTRACT

A motor controller apparatus detects an electric current phase of a drive current supplied to a stepping motor, detects a rotational phase of a rotor of the stepping motor, obtains a phase difference between the electric current phase detected by the first detection unit and the rotational phase detected by the second detection unit. The apparatus, in a first period, controls the stepping motor such that the phase difference becomes a predetermined phase deviation, and, in a second period in which fluctuation of load on the stepping motor is smaller than in the first period, controls the stepping motor such that the drive current does not fall below a predetermined electric current value.

### BACKGROUND OF THE INVENTION

### Field of the Invention

The present invention relates to a method of controlling a stepping motor.

### Description of the Related Art

A stepping motor is generally driven by an open loop control. For this reason, a stepping motor immediately steps-out if there is insufficient drive current (drive torque). Step-out is suppressed by generating the drive torque so as to sufficiently surpass the envisioned load torque. However, the loss of electric power and vibration sound increases due to a constant surplus of drive current.

Japanese Patent Laid-Open No. 2015-091215 proposes a method to regulate the electric current supplied to a coil of a stepping motor according to the deviation between the drive current phase of the stepping motor and the rotor phase (load angle) of the stepping motor. Japanese Patent Laid-Open No. 10-146095 proposes a method of regulating rotational speed according to the deviation between the drive current phase and the rotor phase of a stepping motor.

According to Japanese Patent Laid-Open No. 2015-091215 and Japanese Patent Laid-Open No. 10-146095, when the load on a stepping motor fluctuates, the drive current changes. Changes to the drive current cause vibration in the motor, which increases vibration sound.

### SUMMARY OF THE INVENTION

The present invention provides a motor controller apparatus comprising: a first detection unit that detects an electric current phase of a drive current supplied to a stepping motor; a second detection unit that detects a rotational phase of a rotor of the stepping motor; an obtaining unit that obtains a phase difference between the electric current phase detected by the first detection unit and the rotational phase detected by the second detection unit; and a control unit that, in a first period, controls the stepping motor such that the phase difference becomes a predetermined phase deviation, and, in a second period in which fluctuation of load on the stepping motor is smaller than in the first period, controls the stepping motor such that the drive current does not fall below a predetermined electric current value.

Further features of the present invention will become apparent form the following description of exemplary embodiments (with reference to the attached drawings).

### BRIEF DESCRIPTION OF THE DRAWINGS

FIG. 1 is a diagram showing an image formation apparatus that has a paper feeding and conveying apparatus.

FIG. 2 is a diagram showing a controller of a motor.

FIG. 3 is a diagram showing a controller of a motor.

FIG. 4 is a diagram showing drive current and voltage waveforms.

FIG. 5 is a diagram showing the functions of a CPU and the like.

FIG. 6 is a sequence diagram showing phase difference setting value control according to an image sequence.

FIGS. 7A and 7B are flowcharts showing motor control.

FIG. 8 is a diagram showing functions of a CPU and the like.

FIG. 9 is a flowchart showing processing for obtaining a phase difference setting value based on a cumulative number of sheets.

### DESCRIPTION OF THE EMBODIMENTS

Image Formation Apparatus

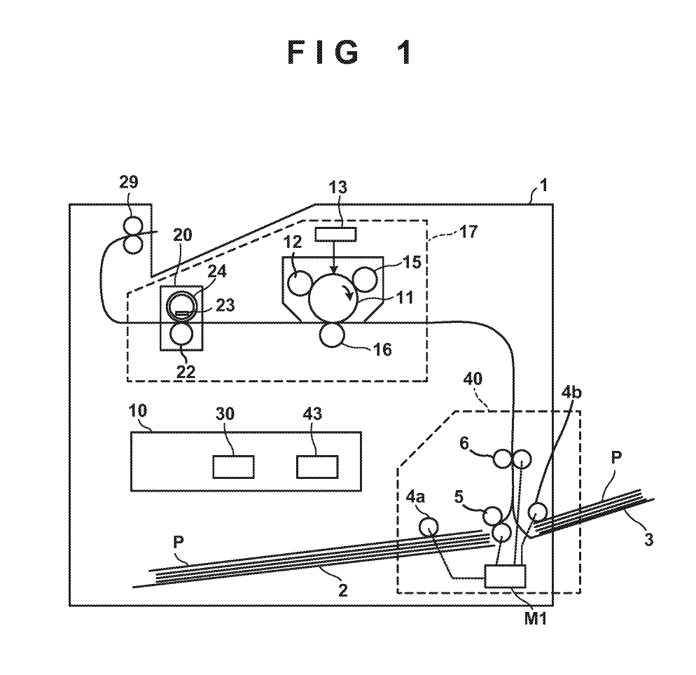

FIG. 1 shows an electrographic image formation apparatus 1 that has a paper feeding and conveying apparatus 40. A feeding cassette 2 and a feeding tray 3 are loading members that load a recording material P. Feeding rollers 4a and 4b are feeding members that send the recording material P to the conveyance path and supply it to an image formation unit 17. A pair of conveyance rollers 5 and a pair of registration rollers 6 are provided in the conveyance path, and are conveyance members that convey the recording material P. The feeding rollers 4a and 4b, the pair of conveyance rollers 5 and the pair of registration rollers 6 form a feeding and conveying unit. The feeding rollers 4a and 4b, the pair of conveyance rollers 5 and the pair of registration rollers 6 are driven by a feeding and conveying motor M1. The feeding and conveying unit and the feeding and conveying motor M1 form the paper feeding and conveying apparatus 40. The feeding and conveying motor M1 controls the position of the recording material P such that an image is formed at a predetermined position on the recording material P. A stepping motor is utilized as the feeding and conveying motor M1.

The image formation unit 17 has a photosensitive drum 11 that carries an electrostatic latent image and a toner image. A charging roller 12 evenly charges the surface of the photosensitive drum 11. An exposure unit 13 modulates a laser beam by an image signal corresponding to an input image, and deflects the laser beam. Through this, the laser beam scans the surface of the photosensitive drum 11, and a latent image is formed. A developing roller 15 uses toner to develop an electrostatic latent image and forms a toner image. A transfer roller 16 transfers the toner image that has been conveyed from the photosensitive drum 11 to the recording material P. A fixing device 20 applies heat and pressure to the toner image that has been transferred to the recording material P while the recording material P is conveyed, thus fixing the toner image to the recording material P. A pressure roller 22 is biased such that it abuts a fixing film 24. A fixing heater 23 abuts an inner circumferential surface of the cylindrical fixing film 24. A paper ejection roller 29 ejects the recording material P to which a toner image has been fixed by the fixing device 20.

A control unit 10 is a controller that controls the members of the image formation apparatus 1. The control unit 10 functions as a motor control apparatus that has a CPU 30 and a motor control unit 43. The CPU 30 transmits feeding instructions to the motor control unit 43. The motor control unit 43 drives the motor M1 in accordance with the feeding instructions. The motor M1 feeds the recording material P from the feeding cassette 2, and conveys it to the image formation unit 17. The CPU 30 selects the image formation conditions according to the type of recording material P. The image formation conditions include the fixing heat of the fixing device 20, the transfer voltage and transfer current applied to the transfer roller 16, and the conveying speed of the recording material P. Here, in order to provide a simple description, an embodiment in which a conveyance speed is selected in accordance with the type of recording material P has been described, but other image formation conditions are capable of being selected according to the type of recording material P.

Motor Control Unit

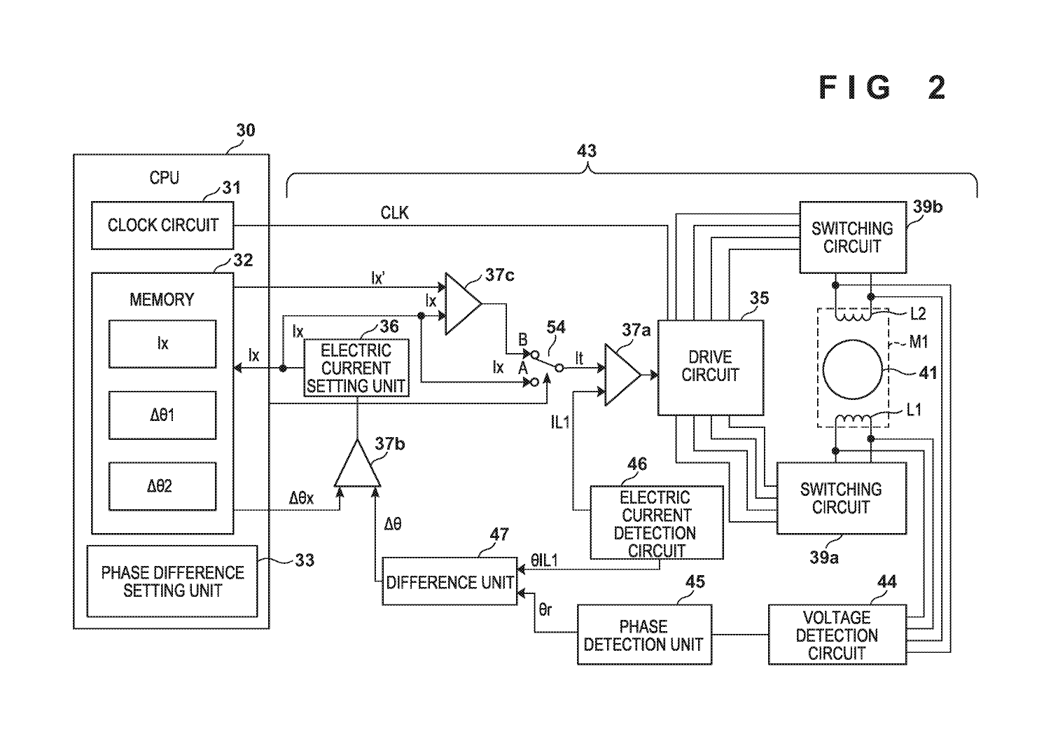

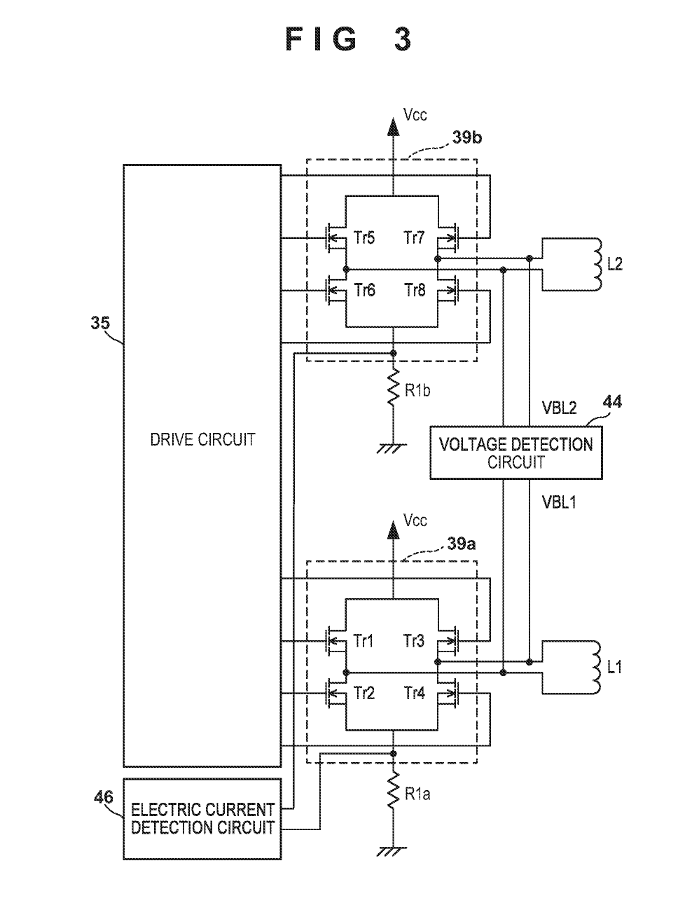

FIGS. 2 and 3 show the CPU 30 and the motor control unit 43. The motor M1 has a rotor 41 and coils L1 and L2. The coils L1 and L2 are provided on a stator. The rotor 41 has a magnet. The one coil L1 is connected to a switching circuit 39a, and the coil L2 is connected to a switching circuit 39b. The CPU 30 has a clock circuit 31 that generates a clock signal CLK for driving the motor M1. The motor control unit 43 receives the clock signal CLK generated by the clock circuit 31 and causes the motor M1 to rotate only by an angle corresponding to the number of the received clock signal CLK. In synchronization with the clock signal CLK, a drive circuit 35 controls the switching circuits 39a and 39b, and controls the drive current supplied to the coils L1 and L2.

As shown in FIG. 3, the switching circuit 39a is a half bridge circuit that is formed by four transistors Tr1 to Tr4. The switching circuit 39b is a half bridge circuit that is formed by four transistors Tr5 to Tr8. These half bridge circuits perform a switching operation based on a drive signal output by the drive circuit 35. Through this, the voltage across the coils L1 and L2 is switched. An electrical source Vcc supplies electric power to the motor M1 via the switching circuits 39a and 39b. An electric current detection resistor R1a is a voltage conversion circuit that converts a coil current which flows in the coil L1 into voltage. An electric current detection resistor R1b is a voltage conversion circuit that converts a coil current which flows in the coil L2 into voltage. Because the switching circuit 39a and the switching circuit 39b are operated in the same manner, the following primarily describes the operation of the switching circuit 39a.

A detection signal (voltage signal) that shows the voltage value detected by the current detector resistor R1a is input to an electric current detection circuit 46. The electric current detection circuit 46 has an amplification circuit that amplifies the detection signal, and noise filter that removes noise contained in the detection signal. The detection signal output by the electric current detection circuit 46 is input to a comparator 37. The comparator 37a compares a target value It output from an electric current selection circuit 54 to an electric current value IL1 output from the electric current detection circuit 46, and controls the drive circuit 35 such that IL1 approaches It. For example, if IL1 is greater than It, the drive circuit 35 reduces the ON time of the transistors Tr1 to Tr4, which form the switching circuit 39a, and causes the drive current that flows in the coil L1 to decrease. The drive circuit 35 maintains the ON time if IL1 is equal to It. If IL1 is less than It, the drive circuit 35 increases the ON time and causes the drive current that flows in the coil L1 to increase. In the same manner, the drive circuit 35 controls the ON time of the transistors Tr5 to Tr8 which form the switching circuit 39b based on the electric current IL2 that flows in the coil L2. As an example, the drive circuit 35 drives the coils L1 and L2 with a 1-2 phase excitation system.

A voltage detection circuit 44 is a circuit that detects the counter electromotive voltage that occurs in the coils L1 and L2. A phase detection unit 45 determines a motor phase θr based on a phase θvb of the counter electromotive voltage of the coils L1 and L2 that was acquired by the voltage detection circuit 44. The phase detection unit 45 may have a conversion circuit, conversion table, or the like, that converts the phase θvb of the counter electromotive voltage to the rotor phase θr. A difference unit 47 computes the phase difference Δθ between the phase θIL1 of the electric current detected by the electric current detection circuit 46 and the rotor phase θr obtained by the phase detection unit 45. In particular, the phase difference Δθ is detected in order to prevent the motor M1 from stepping out.

A comparator 37b compares the phase difference Δθ obtained by the difference unit 47 and a setting value ΔθX of the phase difference that has been set by a phase difference setting unit 33 of the CPU 30, and outputs the comparison result to the electric current setting unit 36. An electric current setting unit 36 adjusts the setting value Ix according to the result of the comparison. The electric current setting unit 36 increases the setting value Ix if the result of the comparison output from the comparator 37b shows that the setting value Δθ is greater than the setting value ΔθX. Through this, step-out of the motor M1 can be controlled.

The phase difference setting unit 33 holds setting values Δθ1 and Δθ2 of a plurality of phase differences. The setting values Δθ1 and Δθ2 may be referred to as a first phase deviation and a second phase deviation respectively (Δθ1<Δθ2). The setting values Δθ1 and Δθ2 may be stored in a memory 32. The phase difference setting unit 33 selects either the setting value Δθ1 or Δθ2 according to a sequence that is executed by the image formation apparatus 1, and outputs it to the comparator 37b. The setting value Δθ1 is set to 90 deg or higher. This is because the highest efficiency of the motor M1 is achieved when the phase difference Δθ is 90 deg. Note that if the phase difference Δθ falls below 90 deg, then a margin (allowance) of the output torque (drive torque) of the motor M1 with respect to the load torque decreases. The setting value Δθ1 may be set to 90 deg or higher in order to maintain enough margin output with respect to the load. The setting value Δθ2 is set to a value that is greater than Δθ1 and less than 180 deg. For example, the setting value Δθ2 is set less than or equal to 135 deg. The motor M1 steps-out if the phase difference Δθ becomes greater than or equal to 180 deg. Accordingly, the phase setting value Δθ2 is always set to a value less than 180 deg. In particular, if the setting value Δθ2 is set equal to or less than 135 deg, a sufficient level of margin in the phase difference to prevent step-out is ensured. For these reasons, the setting value Δθ2 is assumed to be 135 deg in the present embodiment.

In the present embodiment, in a first period in which the load of the motor M1 is likely to vary, the drive current of the motor M1 is controlled according to the phase difference Δθ in order to suppress step-out. This may be referred to as phase difference priority control. This means that in the first period, the drive current supplied to the coils L1 and L2 is changed such that the phase difference Δθ between the electric current phase θIL1 and the rotor phase θr becomes a predetermined phase difference. Also, in the second period in which the load of the motor M1 is unlikely to vary, the drive current is controlled such that variation in the drive current becomes smaller. That is, vibration of the motor M1 is suppressed in the second period. This may also be referred to as electric current priority control. That is, in the second period, a drive current with a constant electric current value is supplied to the coils L1 and L2. Note that, as previously stated, in order to handle an unforeseen load, there are cases in which phase difference priority control is executed temporarily in a second period.

In the first period in which the load of the motor M1 is likely to change, the phase difference setting unit 33, selects the setting value Δθ1 (=90 deg) as the setting value Δθ. In such a case, the CPU 30 connects the electric current selection circuit 54 to a point A side. Through this, the setting value Ix, which is output by the electric current setting unit 36, is input to the comparator 37a. In the first period, the setting value Ix is adjusted as needed according to the difference between the phase difference Δθ and the setting value Δθ. Through this, it is unlikely for step-out to occur even if the load of the motor M1 changes. In the second period in which the load of the motor M1 is stable, the phase difference setting unit 33 selects the setting value Δθ2 (=135 deg). In such a case, the CPU 30 connects the electric current selection circuit 54 to the point B side. Through this, the result of the comparison output by the comparator 37c is input to the comparator 37a. In the second period, the setting value Ix′ stops updating and becomes a fixed value (constant value). Therefore, variation in the drive circuit is unlikely to occur, and it is unlikely for vibration to occur. Note that there may be cases in which an unforeseen load increase occurs and the phase difference Δθ exceeds the setting value Δθ2. In order to prevent step-out in such a case, an electric current that exceeds the setting value Ix′ (the electric current value Ix according to the difference between the phase difference Δθ and the setting value Δθ2) is utilized as the target value It of the drive circuit.

In the first period, the CPU 30 successively overwrites and stores the electric current value Ix that has been set by the electric current setting unit 36 in the memory 32. The electric current value Ix held in the memory 32 is noted as the electric current value Ix′. When the CPU 30 changes the setting value Δθ from Δθ1 to Δθ2, an overwriting operation (update processing) of the memory 32 is stopped such that the stored electric current value Ix′ is not updated. In this way, the electric current value Ix′ that is set in the first period is utilized as a reference value without being changed. This helps to conserve electricity.

The comparator 37c compares the electric current value Ix′ stored in the memory 32 to the electric current value Ix of the electric current setting unit 36, and in a case in which the electric current value Ix is greater than or equal to the electric current value Ix′, it outputs the electric current value Ix to the comparator 37a. In a case in which the electric current Ix is less than the electric current value Ix′, the comparator 37c outputs the electric current value Ix′ stored in the memory 32 to the comparator 37a. Through this, the drive current is prevented from falling below the predetermined electric current.

Detection of Counter Electromotive Voltage

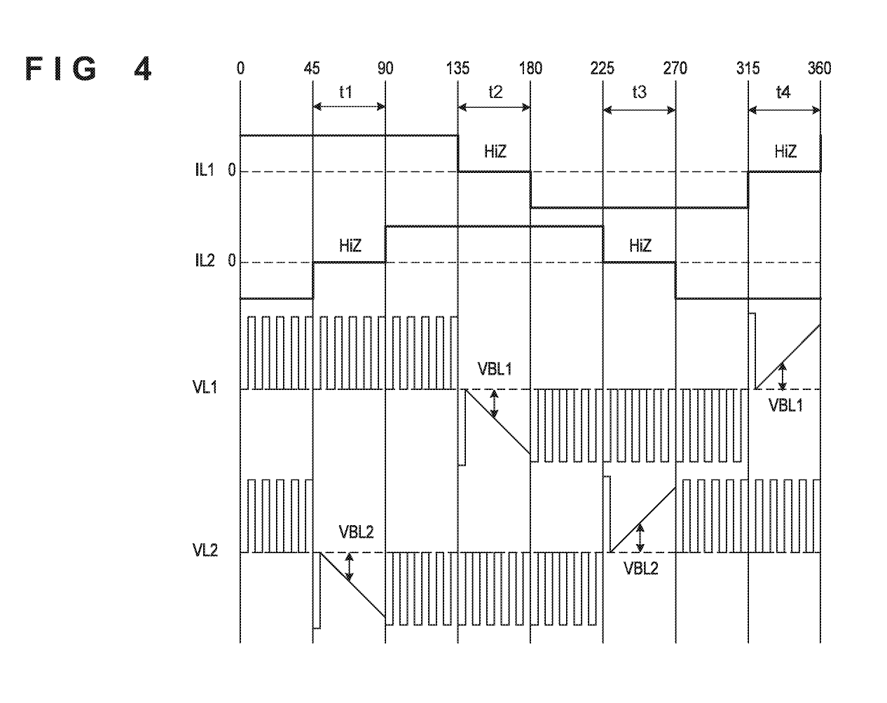

FIG. 4 shows the relationship between coil currents I11 and I12, coil voltages VL1 and VL2, and counter electromotive voltages VBL1 and VBL2. A period t1 is the period of the phase from 45 degrees to 90 degrees. A period t2 is the period of the phase from 135 degrees to 180 degrees. A period t3 is the period of the phase from 225 degrees to 270 degrees. A period t4 is the period of the phase from 315 degrees to 360 degrees. HiZ is an abbreviation for high impedance.

In periods t2 and t4, the motor control unit 43 turns off the output of the switching circuit 39a, and sets the coil L1 to high impedance. Also, in periods t1 and t3, the motor control unit 43 turns off the output of the switching circuit 39b to OFF, and sets the coil L2 to high impedance. In periods t1 to t4, the voltage detection circuit 44 measures the counter electromotive voltages VBL1 and VBL2. The counter electromotive voltages VBL1 and VBL2 are used in order to detect phases of the rotor 41.

A 1-2 phase excitation system coil drive method is shown in the present embodiment. However, even with another system such as a 1 phase excitation system or a 2 phase excitation system, the CPU 30 can detect the counter electromotive voltage VB by providing a high impedance period.

Paper Feeding and Conveying Apparatus

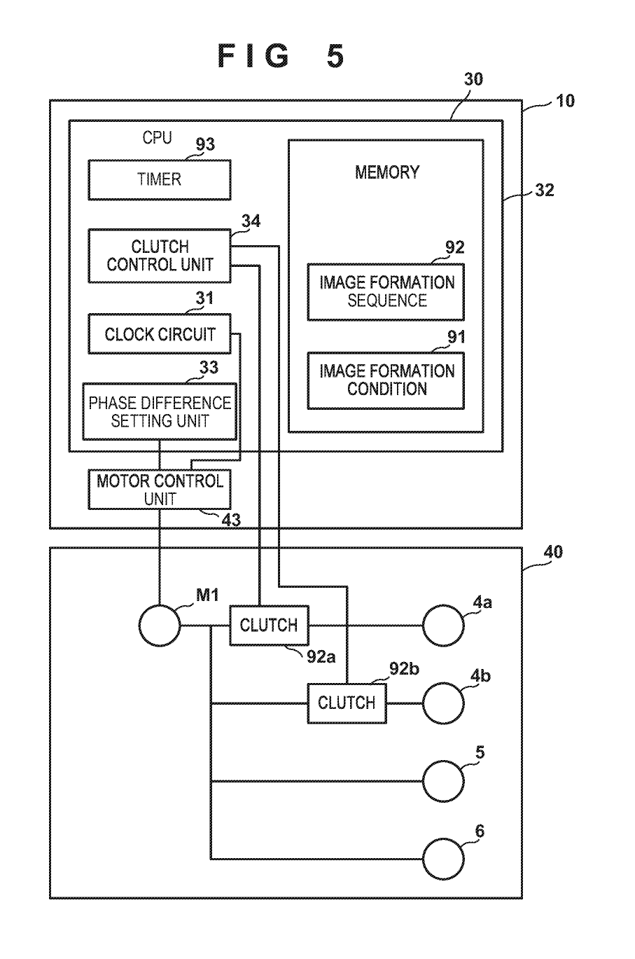

FIG. 5 shows the paper feeding and conveying apparatus 40 and the control unit 10. The control unit 10 may be arranged inside the paper feeding and conveying apparatus 40. The CPU 30 outputs drive instructions for the motor to the motor control unit 43 such that the rotational speed is in accordance with an image formation condition 91. This instruction may be given by, for example, the clock circuit 31 generating and outputting a clock signal CLK of a frequency corresponding to a rotational speed that is in accordance to the image formation condition 91. The motor control unit 43 drives the motor M1 such that it rotates at a rotational speed corresponding to the input clock signal CLK frequency. The motor M1 transmits driving power to the feeding rollers 4a and 4b via clutches 92a and 92b, and rotates the feeding rollers 4a and 4b. The CPU 30 switches on the clutches 92a and 92b at a predetermined timing in accordance with an image formation sequence 94, and feeds the recording material P from a feeding cassette 2 or a feeding tray 3. In a case in which the recording material P is fed from the feeding cassette 2, the CPU 30 switches on the clutch 92a, and the recording material P inside the feeding cassette 2 is fed out from the feeding cassette 2 by the feeding roller 4a, which is connected to the clutch 92a. The clutch 92a is switched on during the period in which the recording material P is fed out from the feeding cassette 2. The CPU 30 controls the ON timing of the clutch 92a such that the intervals between the prior recording material P and the following recording material P are at predetermined intervals. The same is true if fed from the feeding tray 3. The pair of conveyance rollers 5 and the pair of registration rollers 6 are connected by the motor M1 and gears (not shown) and rotate in accordance with the driving power supplied from the motor M1. According to the above described series of operations, the recording material P that was loaded to the feeding cassette 2 or the feeding tray 3 is conveyed in the following order: from the feeding rollers 4a and 4b to the pair of conveyance rollers 5 and then to the pair of registration rollers 6.

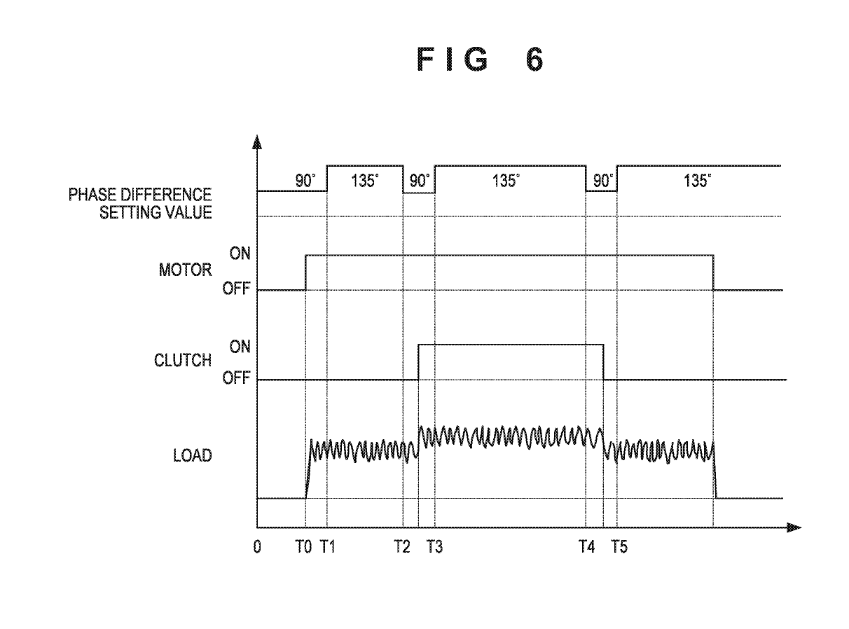

FIG. 6 shows the load on the motor shaft of the motor M1 (motor shaft load). The motor shaft load always includes the load torque of the pair of conveyance rollers 5 and the pair of registration rollers 6 that are driven in synchronization with the rotations of the motor M1. Furthermore, when the clutch 92a is switched on, the load of the feeding roller 4a is added to the load on the motor shaft, and therefore the load on the motor shaft further increases. If the clutch 92a is switched off, the motor shaft load returns to the sum of the load torque received from the pair of conveyance rollers 5 and the load torque received from the pair of registration rollers 6.

The phase difference setting unit 33 changes the setting value of the phase difference according to the load on the motor M1. In FIG. 6, the phase difference setting unit 33 sets the phase difference setting value Δθx to Δθ1 (=90 deg) in order to start the motor M1. The motor M1 starts at a time T0. At a time T1, the motor M1 reaches a target speed, and the phase difference setting unit 33 sets the setting value Δθx to Δθ2 (=135 deg). At time T2, which is a little before the timing of the clutch 92a being switched on, the setting value Δθx is set to Δθ1 (=90 deg). This is to prepare for predicted fluctuations of load. The clutch control unit 34 switches the clutch 92a on during the period between the time T2 and the time T3. This increases the motor shaft load. At the time T3, the phase difference setting unit 33 sets the setting value Δθx to Δθ2 (=135 deg). At the time T4, which is a little before the timing of the clutch 92a being switched to OFF, the phase difference setting unit 33 sets the setting value Δθx to Δθ1 (=90 deg). At the time T5, which is after the clutch 92a has been switched off, the phase difference setting unit 33 sets the setting value Δθx to Δθ2 (=135 deg). Note that the CPU 30 stops the motor M1 when the image formation has ended or the recording material conveying has ended. If the phase difference is set to 90 deg in the first period in which the load is likely to fluctuate, the ability to track a load fluctuation of the motor M1 improves. As mentioned above, if the motor M1 is driven such that the phase difference Δθ becomes 90 deg, the drive current contributes to torque the most efficiently. In other words, if the phase difference Δθ is set to 90 deg, the amount of adjustment of the drive current is most greatly reflected in the torque.

Flowchart

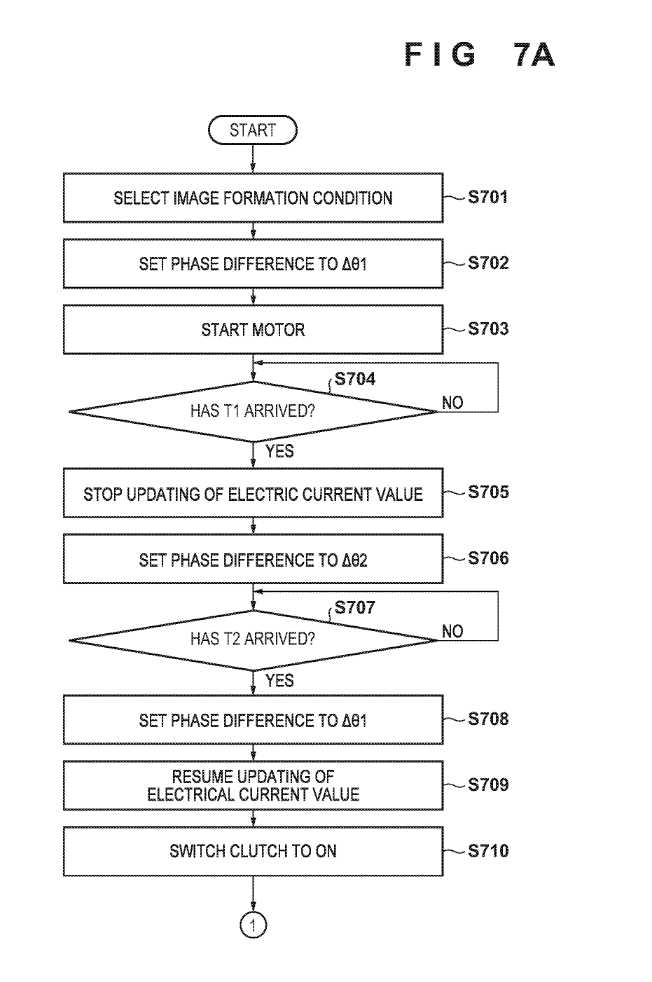

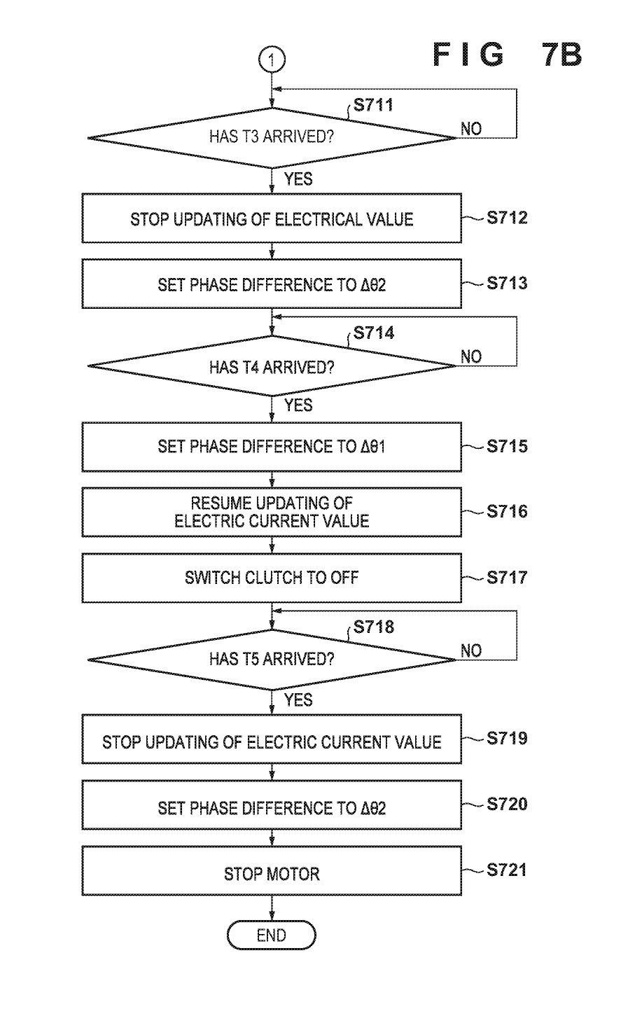

FIGS. 7A and 7B are flowcharts showing processing that the CPU 30 executes. When the image formation apparatus 1 receives a printing job from an external device such as a personal computer (not shown), the CPU 30 executes the following processing. Note that a timer 93 that manages an image sequence is started when the CPU 30 receives a printing job. Here, it is assumed that the supply of the recording material P from the feeding cassette 2 is designated by the printing job. Note that the timings T1 to T5 described below are stored in the memory 32 for every image sequence.

In step S701, in accordance with the received printing job, the CPU 30 selects the image formation sequence 94 and the image formation conditions 91 and proceeds to step S702. The image formation sequence 94 may have, for example, an image sequence for thick paper, an image sequence for standard paper, an image sequence for thin paper, an image sequence for color printing, and an image sequence for double-sided printing. The image formation conditions 91 may have, for example, an image formation condition for thick paper, an image formation condition for standard paper, and an image formation condition for thin paper.

In step S702, the CPU 30 (the phase difference setting unit 33) sets the phase difference Δθx to Δθ1 (=90 deg) as preparation for the operation of supply of the recording material P from the feeding cassette 2. Furthermore, the CPU 30 connects the electric current selection circuit 54 to the point A side, and successively adjusts the drive current of the motor M1 based on the phase difference Δθ between the phase θr of the rotor 41 of the motor M1, and the phase θIL1 of the electric current. The comparator 37b compares the phase difference Δθ and phase difference Δθ1, and the electric current setting unit 36 changes the electric current value Ix according to the result of the comparison. The CPU 30 successively stores the electric current value Ix in the memory 32 as the electric current value Ix′.

In step S703, the CPU 30 starts the motor M1 through the motor control unit 43. For example, the clock circuit 31 begins to generate the clock signal CLK at a frequency proportional to the rotational speed based on the image formation conditions 91. The clock signal CLK is input to the drive circuit 35. The drive circuit 35 controls the switching circuits 39a and 39b in accordance with the clock signal CLK, and starts the driving of the motor M1. Through this, the motor M1 begins to rotate.

In step S704, the CPU 30 determines whether or not the count value of the timer 93 has reached T1. T1 is, for example, the time at which the motor M1 reaches a predetermined speed. When the count value reaches T1, the CPU 30 proceeds to step S705.

In step S705, the CPU 30 stops the updating of the electric current value Ix′.

In step S706, the CPU 30 changes the phase difference Δθx to the setting value Δθ2 (=135 deg) and connects the electric current selection circuit 54 to the point B side. Here, the memory 32 stores the electric current value Ix′ obtained when the motor M1 was controlled based on the setting value Δθ1 (=90 deg). The comparator 37c sets to the comparator 37a the larger one of the electric current value Ix′ based on the setting value Δθ1 and the electric current value Ix′ based on the setting value Δθ2 (=135 deg). Accordingly, the motor M1 is driven by a drive current that is greater than or equal to the drive current when (the motor is) controlled' based on the setting value Δθ1 (=90 deg).

In step S707, the CPU 30 determines whether or not the count value reaches T2. T2 is a time that is a little before the timing at which the recording material P is supplied from the feeding cassette 2.

In step S708 the CPU 30 sets the setting value Δθ1 (=90 deg) to the phase difference Δθx. In other words, the phase difference Δθx returns to the setting value Δθ1 from the setting value Δθ2.

In step S709, the CPU 30 resumes the updating of the electric current value Ix′ to the memory 32. Also, the CPU 30 connects the electric current selection circuit 54 to the point A side.

In step S710, the CPU 30 switches the clutch 92a on.

In step S711, the CPU 30 determines whether or not the count value has reached T3. T3 is the time after the clutch 92a has been switched on, and is also the time when the fluctuation of the load on the motor M1 is small enough. When the count value reaches T3, the CPU 30 proceeds to step S712.

In step S712, the CPU 30 again stops the updating of the electrical current value Ix′. Through this, load is applied to the motor M1 by the clutch 92a being switched on, and the setting value Ix′ of the drive current when the phase difference is Δθ1 (=90 deg) is stored in the memory 32.

In step S713, the CPU 30 sets the phase difference Δθx to Δθ2 (=135 deg), and connects the electric current selection circuit 54 to the point B side.

In step S714, the CPU 30 determines whether or not the count value has reached T4. T4 is the time at which the leading end of the recording medium P reaches the pair of registration rollers 6 from the feeding cassette 2. The comparator 37 sets the larger one of the electric current value Ix′ stored in the memory 32 and the present electric current value Ix in the comparator 37a and controls the motor M1. Here, the electric current value Ix′ that is stored in the memory 32 is the electric current value Ix′ obtained in the period between T3 and T4. In other words, the electric current value Ix′ is the electric current value when the clutch 92a is in the ON state and the phase difference is Δθ1 (=90 deg). The present electric current value Ix is the electric current value when the phase difference is Δθ2 (=135 deg). When the count value has reached T4, the CPU 30 proceeds to step S715.

In step S715 the CPU 30 sets the setting distance Δθ1 (=90 deg) to the phase difference Δθx. In other words, the phase difference Δθx returns to the setting value Δθ1 from the setting value Δθ2.

In step S716, the CPU 30 resumes the updating of the electric current value Ix′ to the memory 32. Also, the CPU 30 connects the electric current selection circuit 54 to the point A side.

In step S717, the CPU 30 switches the clutch 92a to OFF.

In step S718, the CPU 30 determines whether or not the count value has reached T5. T5 is, for example, the timing when the rear end of the recording material P has passed through the pair of registration rollers 6. When the count value reaches T5, the CPU 30 proceeds to step S719.

In step S719, the CPU 30 stops the updating of the electric current value Ix′.

In step S720, CPU 30 sets the phase difference to Δθ2 (=135 deg). The CPU 30 sets the larger one of the electric current value Ix′ stored in the memory 32 since T5 and the present electric current value Ix in the comparator 37a. The electric current value Ix′ is the electric current value when the clutch 92a is in the OFF state and the phase difference is Δθ1 (=90 deg).

In step S721, the CPU 30 stops the output of the clock signal CLK to the motor control unit 43. Through this, the motor M1 stops. Thereafter, the CPU 30 executes image formation.

In an embodiment such as the present embodiment, the electric current value for the purpose of driving the motor M1 is controlled according to the timing at which load fluctuations is assumed to occur, and the phase difference between the phase of the rotor 41 and the electric current phase. In other words, in a first period in which load fluctuation is likely to occur, the electric current value of the motor M1 changes successively according to the load. Also, in a second period in which load fluctuation is not likely to occur, the motor M1 is controlled such that the electric current value of the motor M1 is not likely to change. For example, the present electric current value is reflected in the control of the motor M1 only when the present electric current value (setting value Ix) exceeds the previous electric current value (the setting value Ix′). For that reason, the change in the current of the motor M1 become smaller and the vibration of the motor M1 reduces.

Variations

The present embodiment describes a method of reflecting the cumulative number of sheets conveyed by the paper feeding and conveying apparatus 40 in the phase difference setting values.

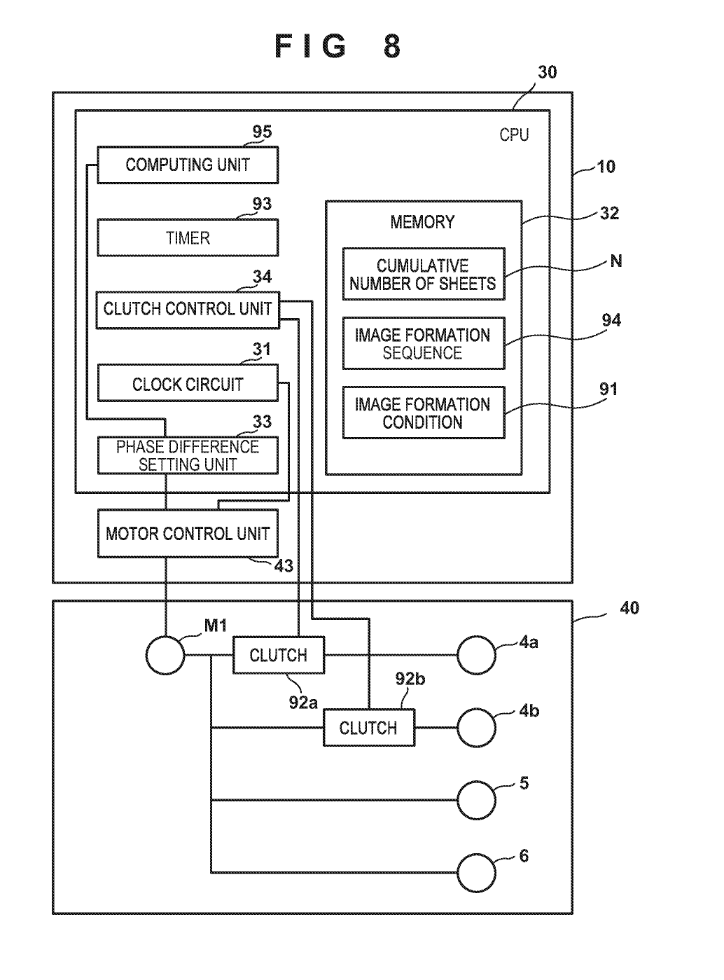

FIG. 8 shows the paper feeding and conveying apparatus 40 and the control unit 10. Parts which have already been described have the same reference numerals and have their descriptions omitted. The memory 32 holds the cumulative number of sheets N of the recording material P that were conveyed by the paper feeding and conveying apparatus 40. A computing unit 95 computes the setting value Δθ3 of phase difference based on the predetermined setting value Δθ2 of phase difference and the cumulative number of sheets N. In this variation, Δθ3 is used instead of Δθ2 and control is performed. The computing unit 95 may use the expression below.

Δθ3=Δθ2+(N/M)×10 deg (1)

Here, M is the cumulative number (the guaranteed number) that ensures that the recording material P can be properly conveyed by the paper feeding and conveying apparatus 40. Δθ3 increases from Δθ2 with the increase of the cumulative number of sheets N. But, Δθ3 is set such that it is below 180 deg. The computing unit 95 may compute Δθ3 by adding the corrected value that is set with each predetermined cumulative number of sheets to Δθ2. Note that abrasion occurs to the bearings of the rollers in the paper feeding and conveying apparatus 40 with an increase of the cumulative number of sheets, and also changes the load on the motor M1. In other words, an appropriate setting value Δθ2 changes according to the cumulative number of sheets.

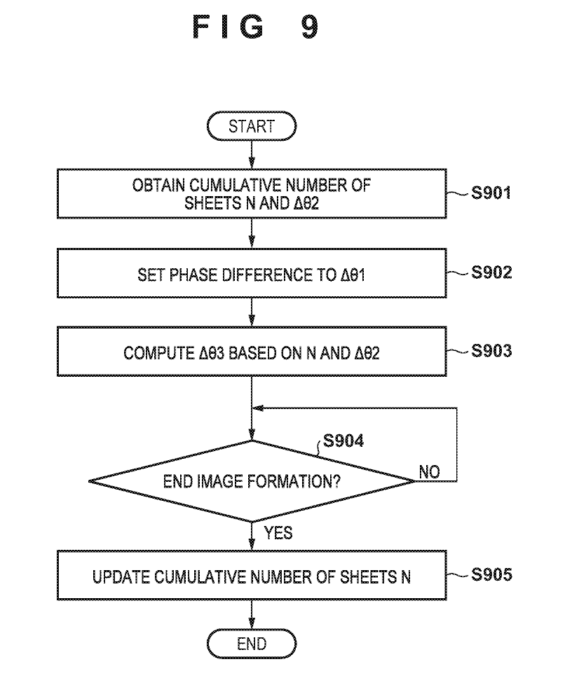

FIG. 9 is a flowchart that shows processing executed by the computing unit 95 of the CPU 30. The CPU 30 executes the following processing when a print job is received.

In step S901, the computing unit 95 obtains the cumulative number of sheets N and Δθ2 from the memory 32. Note that the cumulative number of sheets N may be counted and stored by a counter.

In step S902, the computing unit 95 computes Δθ3 based on the phase difference setting value Δθ2, cumulative number of sheets N and the ensured number of sheets M.

In step S903, the computing unit 95 stores Δθ3, which is the computed result, in the memory 32.

In step S904, the computing unit 95 judges whether or not image formation has ended. For example, when an image has been formed on all of the image recording materials P that are specified by a printing job the computing unit 95 judges that image formation has ended.

In step S905, the computing unit 95 adds the number of sheets of the recording material P that were conveyed by the present printing job to the cumulative number of sheets N, and updates the cumulative number of sheets N stored in the memory 32.

Here, Δθ3 is computed with each printing job, but Δθ3 may be calculated each time a sheet of the recording material P is conveyed. According to the present embodiment, it is possible to appropriately set the phase difference for the paper feeding and conveying apparatus 40 in which the load on the motor M1 changes depending on the cumulative number of sheets.

### SUMMARY

As described using FIG. 2, the electric current detection circuit 46 is an example of the first detection unit that detects the electric current phase of the drive current that is supplied to the stepping motor. The phase detection unit 45 is an example of the second detection unit that detects rotational phases of the rotor 41 of the stepping motor. The difference unit 47 is an example of the obtaining unit that obtains the phase difference Δθ between the electric current phase θIL1 and the rotational phase θr. The CPU 30 and the motor control unit 43 are examples of the control unit that controls the stepping motor such that the phase difference becomes a predetermined phase deviation in the first period, and controls the stepping motor such that the drive current does not fall below a designated electric current value in the second period. The first period is a period in which the load of the stepping motor is likely to change. The second period is a period in which the load on the stepping motor is not likely to fluctuate (a period of load stability). In other words, fluctuations in load on the stepping motor are smaller in the second period than the first period. Because the stepping motor is controlled according to the phase difference in the first period, it is unlikely for step-out to occur. Also, in the second period, because the fluctuations of the drive current becomes smaller, increases in vibration sound of the stepping motor is suppressed.

The phase difference setting unit 33 is an example of the setting unit that sets the first phase deviation in the first period (for example: 0 to T1, T2 to T3, or T4 to T5) in which the stepping motor to is likely to fluctuate. Also, the phase difference setting unit 33 is an example of the setting unit that sets the second phase deviation that is bigger than the first phase deviation in the second period (for example: T1 to T2 or T3 to T4) in which the stepping motor is unlikely to fluctuate. The motor control unit 43 is an example of the electric current control unit that controls the drive current according to the result of comparing the first phase deviation (the phase difference Δθ1) or the second phase deviation (phase difference Δθ2) and the phase difference Δθ. As shown in FIG. 6, the first period may be a period (for example: 0 to T1) in which the load on the stepping motor changes from no load to the first load. Also, the first period may be a period (T2 to T3) in which the load on the stepping motor increases from a first load to a second load by the clutches 92a and 92b being switched to ON. Also, the first period may be a period (T4 to T5) in which the load on the stepping motor decreases from the second load to the first load by the clutches 92a and 92b being switched to ON. The second period may be a period (T1 to T2) in which the load on the stepping motor becomes the first load, or a period (T3 to T4) in which it becomes the second load. Also, the first period may be a period in which the first phase deviation (phase difference Δθ1) is set by the motor control unit 43 by way of the CPU 30. The second period may be a period in which the second phase deviation (phase difference Δθ2) is set by the motor control unit 43 by way of the CPU 30. The first phase deviation (phase difference Δθ1) is set in advance according to the first load. The second phase deviation (phase difference Δθ2) is set in advance according to the second load.

The motor control unit 43 is configured such that the drive current is controlled in accordance with a first target value that is based on the result of a comparison of the first phase deviation and the phase difference in the first period. In the second period, the motor control unit 43 controls the drive current using, as the second target value, the larger one of the predetermined electric current value (for example, Ix′), which is the first target value in the first period, and an electric current that is based on the results of the comparison of the second phase deviation and the phase difference. Through this, the stepping motor is controlled such that the drive current does not fall below the predetermined electric current value. In this way, the electric current value (for example, Ix′) that is set such that Δθ becomes Δθ1 in the first period, is used as the reference drive current in the second period also. The electric current value set in the first period is the smallest electric current that can maintain a margin of the output torque in relation to the actual load torque. For that reason, the electrical consumption of the stepping motor is comparatively reduced.

The electric current setting unit 36 is an example of the determination unit that determines the electric current value according to the results of a comparison between the first phase deviation and phase difference in the first period. The memory 32 is an example of the storage unit that stores the electric current value that is determined by the determining unit. The comparator 37c is an example of the comparison unit which outputs the larger one of the electric current values (for example, Ix′) stored by the storage unit, and the electric current value (for example, Ix) that is determined by a determining unit according to the results of the comparison of the second phase deviation and the phase difference in the second period, as the reference value. The motor control unit 43 is configured such that the drive current is controlled such that the drive current approaches the reference value.

The CPU 30, the electric current setting unit 36 and the memory 32 are configured so as to update the electric current value in the first period, and to stop the electric current value from updating in the second period. Through this, it is possible to store the electric current value that was determined in the first period in the memory 32 in the second period.

The CPU 30, the counter circuit, and the like are examples of the counter unit that counts the parameter (cumulative number of sheets N, for example) that is correlated to the duration of operation for load driven by the stepping motor. The computing unit 95 is an example of the computing unit that computes the second phase deviation (A03, for example) according to the parameter. Through this, it is possible to adjust the second phase deviation according to long-term load fluctuations. Note that, Δθ2 is used as the initial value of Δθ3.

As shown in FIG. 2, the stepping motor has the first coil L1, the second coil L2, and the rotor 41. Here, the first coil L1 and the second coil L2 are a stator. The rotor 41 has a magnet. The motor control unit 43 may have the first switching circuit that applies the drive current to the first coil, the second switching circuit that applies the drive current to the second coil, and the drive circuit (the drive circuit 35) that drives the first switching circuit and the second switching circuit according to the results of the comparison.

As shown in FIG. 3, the first switching circuit and the second switching circuit may be half bridge circuits. Also, the electric current detection circuit 46 may be provided in the first switching circuit, and may have the resistor R1 that converts the drive current to voltage.

The first phase deviation is greater than or equal to 90 degrees and less than a second phase deviation. Also, the second phase deviation is less than 180 degrees. The second phase deviation may be 135 degrees.

The difference unit 47 is an example of the computing unit that computes the phase difference Δθ of the electric current phase and the rotational phase. As shown in FIG. 6, the phase difference setting unit 33 is an example of the switching unit that switches phase deviations at a timing (T2, T4, for example) at which the load on the stepping motor is predicted to change.

As shown in step S707 and step S714, the CPU 30 functions as the judging unit that judges whether or not the timing of predicted increases or decreases of load on the stepping motor has been reached. The phase difference setting unit 33 is configured such that the phase deviation is set to the first phase deviation (Δθ1, for example) when the predicted timing (T2, for example) of load increase on the stepping motor arrives. Furthermore, the phase difference setting unit 33 is configured such that the phase deviation is set to the second phase deviation (Δθ2, for example) that is bigger than the first phase deviation when the timing (T3, for example) at which the load on the stepping motor is stable arrives.

The phase difference setting unit 33 switches the phase deviation from the second phase deviation to the first phase deviation when the timing (T4, for example) at which it is predicted that the load on the stepping motor will decrease arrives. Furthermore, the phase difference setting unit 33 is configured such that it switches the phase deviation from the first phase deviation to the second phase deviation when a timing (T5, for example) at which the load on the stepping motor is stable arrives. Note that, the phase difference setting unit 33 sets the phase deviation to the first phase deviation in order to start the stepping motor.

The electric current setting unit 36 is an example of the determining unit that determines the setting value of the drive current according to the results of comparing the phase difference and the preset phase deviation. The memory 32 is an example of the storage unit that stores setting values determined in the period in which the first phase deviation is set. The motor control unit 43 may be configured to control the drive current such that it does not become equal to or less than the setting value stored in the memory 32 in the period in which the second phase deviation is set. This decreases the frequency of drive current fluctuations decreases and suppresses the generation of vibration sounds from the motor M1.

The memory 32 updates the setting value in the period in which the load on a stepping motor decreases or increases (0 to T1, T2 to T3, T4 to T5, for example), and stops the setting value from updating in periods in which the load on the stepping motor is stable (T1 to T2, T3 to T4, T5 and after, for example).

The comparator 37c is an example of the selection unit that selects the larger setting value of the setting values stored in the memory 32 and the setting value determined in the period in which the second phase deviation is set as a reference value. The comparator 37a and the drive circuit 35 are examples of the drive circuit that drives the stepping motor such that the drive current is close to the reference value.

The CPU 30 is an example of the obtaining unit that obtains a parameter that increases in correlation with the duration of usage of the load on the stepping motor. The computing unit 95 is an example of the adjustment unit that adjusts the second phase deviation according to the parameter.

The feeding rollers 4a and 4b, the pair of conveyance rollers 5, and the pair of registration rollers 6 are examples of the conveying unit that conveys the recording material P. The motor M1 is an example of the stepping motor that supplies drive force to the conveying unit. The CPU 30 is an example of the counting unit that counts the number of sheets of the recording material P that have been conveyed by the paper feeding and conveying apparatus 40. The image formation unit 17 is an example of the image formation unit that forms images on the recording material P that has been conveyed by the paper feeding and conveying apparatus 40.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-195372, filed Oct. 5, 2017 which is hereby incorporated by reference herein in its entirety.

What is claimed is:

1. A motor controller apparatus comprising:
a first detection unit that detects an electric current phase of a drive current supplied to a stepping motor;
a second detection unit that detects a rotational phase of a rotor of the stepping motor;
an obtaining unit that obtains a phase difference between the electric current phase detected by the first detection unit and the rotational phase detected by the second detection unit; and
a control unit that, in a first period, controls the stepping motor such that the phase difference becomes a predetermined phase deviation, and, in a second period in which fluctuation of load on the stepping motor is smaller than in the first period, controls the stepping motor such that the drive current does not fall below a predetermined electric current value.

2. The motor control apparatus according to claim 1,
further comprising a setting unit that, in the first period, sets in the control unit a first phase deviation as the predetermined phase deviation and, in the second period, sets in the control unit a second phase deviation that is larger than the first phase deviation,
wherein in the first period, the control unit controls the drive current in accordance with a first target value that is based on a comparison result of the first phase deviation and the phase difference, and
in the second period, the control unit controls the stepping motor such that the drive current does not fall below the predetermined electric current value by controlling the drive current with a second reference value that is a larger one of an electric current value that is based on a comparison result of the second phase deviation and the phase difference, and the predetermined electric current value that is the first reference value in the first period.

3. The motor controller apparatus according to claim 2, wherein the control unit includes
a determination unit that determines an electric current value according to a comparison result of the first phase deviation and the phase difference in the first period,
a storage unit that stores the electric current value determined by the determination unit, and
a comparison unit that outputs the larger one of an electric current value stored by the storage unit and an electric current determined by the determination unit according to a comparison result of the second phase deviation and the phase difference in the second period.

4. The motor controller apparatus according to claim 3, wherein the determination unit updates the electric current value in the first period, and stops updating the electric current value in the second period.

5. The motor controller apparatus according to claim 2, further comprising:
a counting unit that counts a parameter correlated to an operation duration of a load driven by the stepping motor; and
a computing unit that computes the second phase deviation according to the parameter.

6. The motor controller apparatus according to claim 2,
wherein the stepping motor has a first coil, a second coil, and a rotor, and
the control unit has
a first switching circuit that applies a drive current to the first coil,
a second switching circuit that applies a drive current to the second coil, and
a drive circuit that drives the first switching circuit and the second switching circuit according to the comparison result.

7. The motor controller apparatus according to claim 6, wherein the first switching circuit and the second switching circuit are each a half bridge circuit.

8. The motor controller apparatus according to claim 7, wherein the first detection unit is provided in the first switching circuit and includes a resistor that changes the drive current to voltage.

9. The motor controller apparatus according to claim 2, wherein the first phase deviation is greater than or equal to 90 degrees.

10. The motor controller apparatus according to claim 2, wherein the second phase deviation is less than 180 degrees.

11. The motor controller apparatus according to claim 2, wherein the second phase deviation is 135 degrees.

13. A motor controller apparatus comprising:
a first detection unit that detects an electric current phase of a drive current supplied to a stepping motor;
a second detection unit that detects a rotational phase of a rotor of the stepping motor;
an obtaining unit that obtains a phase difference between the electric current phase detected by the first detection unit and the rotational phase detected by the second detection unit;
an electric current control unit that controls the drive current according to a comparison result of the phase difference obtained by the obtaining unit and a preset phase deviation; and
a switching unit that sets the phase deviation according to a timing at which a load of the stepping motor is predicted to change.

14. The motor controller apparatus according to claim 13, further comprising a judging unit that judges whether or not a timing at which the load of the stepping motor is predicted to increasing or decrease has arrived,
wherein the switching unit sets the phase deviation to a first phase deviation when a timing at which the load of the stepping motor is predicted to increase arrives, and sets the phase deviation to a second phase deviation that is larger than the first phase deviation when a timing at which the load of the stepping motor is stable arrives.

15. The motor controller apparatus according to claim 14, wherein the switching unit switches the phase deviation from the second phase deviation to the first phase deviation when the timing at which the load on the stepping motor is predicted to decrease arrives, and switches the phase deviation from the first phase deviation to the second phase deviation when the timing at which the load on the stepping motor is stable arrives.

16. The motor controller apparatus according to claim 14, wherein the switching unit sets the phase deviation to the first phase deviation in order to start the stepping motor.

17. The motor controller apparatus according to claim 14, further comprising:
a determining unit that determines a setting value of the drive current according to a comparison result of the phase difference and a preset phase deviation; and
a holding unit that holds the setting value determined in a period in which the first phase deviation is set,
wherein the electric current control unit controls the drive current so as to not fall below a setting value held in the holding unit in a period in which the second phase deviation is set.

18. The motor controller apparatus according to claim 17, wherein the holding unit updates the setting value in a period in which the load of the stepping motor increases or decreases, and stops updating of the setting value in a period in which the load on the stepping motor is stable.

19. The motor controller apparatus according to claim 17, further comprising:
a selection unit that selects, as a target value, a setting value that is a larger one of a setting value held in the holding unit and a setting value determined in a period in which the second phase deviation is set; and
a drive circuit that drives the stepping motor such that the drive current approaches the target value.

20. The motor controller apparatus according to claim 14, further comprising:
an obtaining unit that obtains a parameter that increases in correlation with a usage period of the load of the stepping motor; and
an adjustment unit that adjusts the second phase deviation according to the parameter.

21. A paper feeding and conveying apparatus comprising:
a feeding and conveying unit that feeds and conveys a recording material;
a stepping motor that supplies drive power to the feeding and conveying unit;
a first detection unit that detects an electric current phase of drive current that is supplied to the stepping motor;
a second detection unit that detects a rotational phase of a rotor of the stepping motor;
an obtaining unit that obtains a phase difference between the electric current phase detected by the first detection unit and the rotational phase detected by the second detection unit; and
a control unit that, in a first period of a process of the recording material being fed and conveyed by the feeding and conveying unit, controls the stepping motor such that the phase difference becomes a predetermined phase deviation, and, in a second period of the process of the recording material being fed and conveyed by the feeding and conveying unit in which fluctuation of load of the stepping motor is smaller than in the first period, controls the stepping motor such that the drive current does not fall below a predetermined electric current value.

22. The paper feeding and conveying apparatus according to claim 21,
wherein the feeding and conveying unit includes a feeding member that supplies a recording material loaded by a loading member to a conveyance path, and a conveying member that conveys the recording material supplied to the conveyance path by the feeding member,
the stepping motor drives the feeding member and the conveying member, and
in the process of the recording material being fed and conveyed by the feeding and conveying unit, the control unit transitions to the first period before the stepping motor begins to rotate, and transitions from the first period to the second period after the stepping motor begins to rotate.

23. The paper feeding and conveying apparatus according to claim 22, wherein the paper feeding and conveying apparatus further comprises:
a clutch that that transmits or blocks drive power from the stepping motor to or from the feeding member,
wherein, in the process of the recording material being fed and conveyed by the feeding and conveying unit, the control unit transitions to the first period before the stepping motor begins to rotate in a state in which the drive power from the stepping motor is blocked from the feeding member by the clutch, transitions from the first period to the second period after the stepping motor begins to rotate, transitions from the second period to the first period before drive power is transmitted from the stepping motor to the feeding member by the clutch, and transitions from the first period to the second period after drive power is transmitted from the stepping motor to the feeding member by the clutch.
